(19) United States
(12) Patent Application Publication
(10) Pub. No.: US 2013/0132962 A1
(43) Pub. Date: May 23, 2013

(54) SCHEDULER COMBINATORS

(71) Applicants: Bart De Smet, Bellevue, WA (US); Henricus Johannes Maria Meijer, Mercer Island, WA (US); John Wesley Dyer, Monroe, WA (US)

(72) Inventors: Bart De Smet, Bellevue, WA (US); Henricus Johannes Maria Meijer, Mercer Island, WA (US); John Wesley Dyer, Monroe, WA (US)

(73) Assignee: MICROSOFT CORPORATION, Redmond, WA (US)

(21) Appl. No.: 13/302,761

(22) Filed: Nov. 22, 2011

(51) Int. Cl. G06F 9/46

(52) U.S. Cl. 718/102

(57) ABSTRACT

Scheduler combinators facilitate scheduling. One or more combinators, or operators, can be applied to an existing scheduler to compose a new scheduler or decompose an existing scheduler into multiple facets.

### BACKGROUND

Scheduling refers to a manner of assigning work for execution on available hardware resources, and optionally introducing concurrency. For example, processes or threads can be mapped to one or more central processing units (CPUs) for execution. Assignment of work to available computational resources is carried out by a scheduler. Further, computer systems often include numerous distinct schedulers to deal with particular situations.

A scheduler often comprises two components, namely a data structure and a timer. When actions are scheduled for completion, the actions can be placed in a data structure that allows queuing as a function of priority, for example. The timer corresponds to clock that provides a notion of time with respect to a scheduler such that an action can be scheduled immediately or after a specified time relative to the current time. Further, a mechanism can be provided for canceling a scheduled action, for instance by deleting the action from a queue maintained by the scheduler.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to scheduler combinators. Schedule combinators, or operators implemented as combinators, allow a new scheduler to be created from an existing scheduler or an existing scheduler to be split into multiple schedulers, among other things. As a result, schedulers can be easily composed thereby facilitating scheduling. A variety of operators can be created and applied to schedulers including operators for delaying scheduling of work, performing additional actions, and handling exceptions, amongst many others.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a scheduler generation system.

FIG. 2 is a block diagram depicting combinator application.

FIG. 3 is a block diagram illustrating operation of an ambiguous (Amb) scheduler.

FIG. 4 is a flow chart diagram of a method of facilitating scheduling.

FIG. 5 is a schematic block diagram illustrating a suitable operating environment for aspects of the subject disclosure.

### DETAILED DESCRIPTION

Details below are generally directed toward scheduler combinators. Rather than developing a scheduler with desired functionality from scratch, scheduler combinators allow a new scheduler to be created from an existing scheduler or an existing scheduler to be split into multiple schedulers, among other things. In other words, rich composition of schedulers is enabled. A variety of combinators, or operators implemented as combinators, can be created and applied to schedulers. By way of example, and not limitation, operators are provided for delaying scheduling of work, performing additional actions such as logging, handling exceptions, and scheduling work on a scheduler that is fastest to respond amongst a plurality of schedulers.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

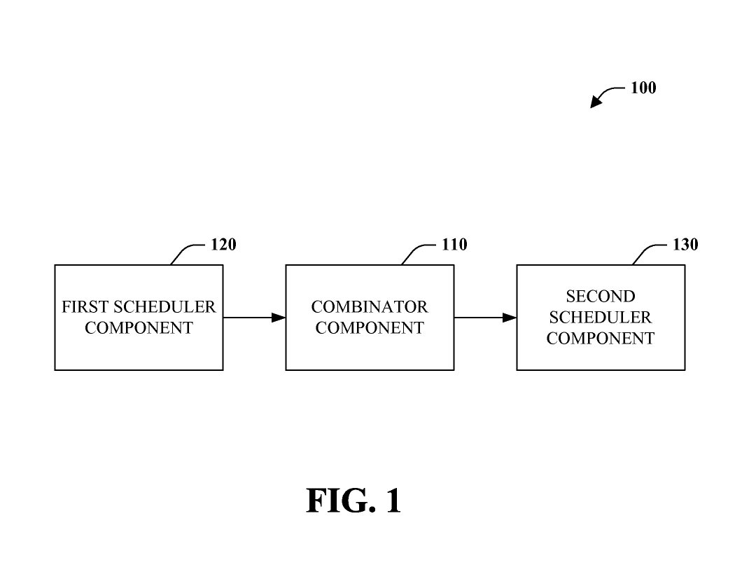

Referring initially to FIG. 1, a scheduler generation system 100 is illustrated. The system includes a combinator component 110 that accepts a first scheduler component 120 as input and outputs a second scheduler component 130. The first scheduler component 120 corresponds to any scheduler configured to schedule execution of work, or an action, on computational resources (e.g., hardware). The second scheduler component 130 corresponds to a new scheduler that is a transformed version of the first scheduler component 120. In other words, the second scheduler component 130 can represent the first scheduler component plus some additional logic, for example. This is analogous to placing a sub sandwich (first scheduler) into a toaster oven (combinator), the result of which is a transformed sub sandwich, namely a toasted sub (second scheduler).

The combinator component 110 can be configured to apply a function, or operator, to a scheduler and output a new scheduler, optionally based on some additional arguments (e.g., in addition to the input scheduler). Furthermore, the combinator component 110 is configured to enable composition of schedulers or more specifically composition of functions, or, in other words, operators, over schedulers. More formally, consider the follow expression: “(f·g) x=f(g(x)).” Here, “f” and “g” denote two different functions, or operators, and “x” represents a scheduler. The sub-expression “(f·g) x” symbolizes composition of “f” and “g” applied with respect to “x.” This sub-expression is equal to “f(g(x)),” or application of function “f” to the result of the application of function “g” to “x.” In this manner, scheduler combinators, or operators implemented as combinators, can be linked, or chained, together in a sequence. With respect to FIG. 1, this can correspond to applying another combinator component to the second scheduler component 130, the output of the combinator component 110.

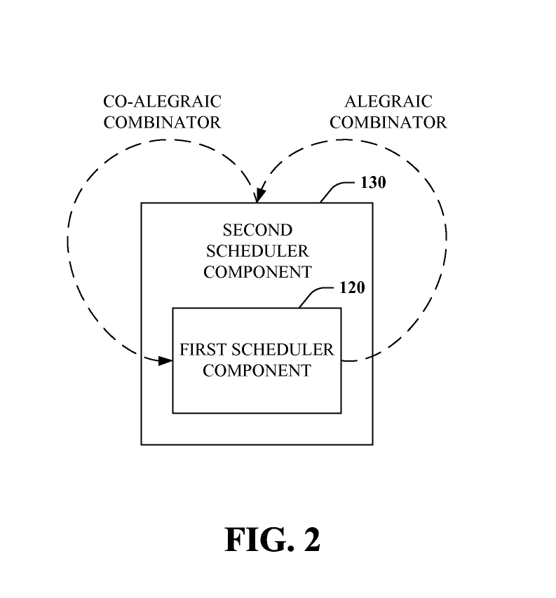

FIG. 2 illustrates combinator application to aid clarity and understanding with respect to aspects of this disclosure. There are two types of combinators, namely algebraic and co-algebraic. Generally and abstractly speaking, an algebraic combinator can combine a scheduler with other schedulers to derive a new composite scheduler, and a co-algebraic combinator can split a scheduler into multiple derived schedulers. More particularly, a new scheduler can be generated by application of an operator on an existing scheduler, or one or more derived schedulers can be produced by application of an operator on an existing scheduler, respectively. As will be discussed later herein, combinators are not limited to working solely with respect to schedulers. As shown with respect to the first scheduler component 120 and the second scheduler component 130 of FIG. 1, applying an algebraic combinator to the first scheduler component 120 produces the second scheduler component 130 that adds some logic to the first scheduler component 120. This corresponds to combining two schedulers to produce a composite scheduler. By applying a co-algebraic combinator to the second scheduler component 130, the process can be reversed. In other words, the first scheduler is derived from the second composite scheduler.

Schedulers can be employed in many different contexts. In accordance with one embodiment, schedulers can be employed in the domain of reactive programming and more particular with respect to reactive expressions. Reactive expressions are expressions that are continuously evaluated over time in response to changes in data (e.g., push-based data or observable sequence). Here, a scheduler can control when a subscription starts as well as when notifications (e.g., data) are published, or pushed to subscribers. Further, schedulers can be specified within a reactive expression. Thus, the compositionality of schedulers can be exploited to aid generation of reactive expressions.

There are innumerable possibilities for operators that can be applied to a scheduler. What follows are identification and a brief description of several exemplary operators that can be employed with respect to schedulers. Furthermore, the operators are described with respect to a particular implementation. The claimed subject matter is not intended to be limited to the identified and discussed operators nor the particular implementation details. Rather, the intent is to provide some sample operators with respect to a specific implementation to aid clarity and understanding and not to implicitly limit the scope of the claimed subject matter thereto.

As previously noted, schedulers are a mechanism, or means, for scheduling work for execution on computational resources (e.g., hardware), and optionally introducing concurrency. In one embodiment, a scheduler can implement an interface as shown below:

public interface IScheduler
{

DateTimeOffset Now { get; }
IDisposable Schedule(Action action);
IDisposable Schedule(Action action, TimeSpan dueTime);

}

Each implementation of a scheduler has a notion of the current time and can take an action to be scheduled either as soon as possible or at a given change in time relative to the current time. Scheduler methods can return an “IDisposable” that can be utilized to cancel a scheduled action, for example by deleting the action from queue utilized by a scheduler to dispatch work.

In accordance with one non-limiting implementation, combinators, or operators implemented as combinators (a.k.a., simply operators), can be defined as extension methods on the above “IScheduler” that return an “IScheduler” themselves. This allows for composition of schedulers and layering aspects on top of existing schedulers without any change to a scheduler's code. In order to simplify the implementation of returned schedulers, an “Anonymous Scheduler” and a factory method “Scheduler.Create” can be created, both of which can take in an interface member implementation as a delegate. In C#® syntax:

var immediate = Scheduler.Create(

( ) => DateTime.Now,
a => { a( ); return Disposable.Empty; },
(a, t) => { Thread.Sleep(t.Milliseconds); a( ); return
Disposable.Empty; }

);

The above is a straightforward implementation of an immediate scheduler, which executes given actions immediately; hence, it is synchronous with respect to a caller. A true non-trivial scheduler can store a given action somewhere and run the action in parallel, or concurrently, with the caller (or maybe another machine), returning an “IDisposable” (e.g., a dispose method that when called releases resources) that can be used to cancel the work.

The following are several operators that can be implemented as combinators over “IScheduler” objects (a.k.a., schedulers or scheduler components). These are samples only with possible shortcomings in implementations.

One operator is “Delay,” which creates a new “IScheduler” object that forwards work to an underlying scheduler with a given delay. Stated differently, calls to any schedule method on such a delayed scheduler result in calls to the “Schedule(Action, TimeSpan)” method of the original scheduler, shifting the due time a given amount:

public static IScheduler Delay(this IScheduler scheduler, TimeSpan delay)
{

return new AnonymousScheduler(

a => scheduler.Schedule(a, delay),
(a, t) => scheduler.Schedule(a, t + delay),
( ) => scheduler.Now

);

}

Notice for linear operators like “Delay,” providing an implementation for the “Now” property getter is straightforward—simply return whatever the underlying scheduler provides. For operators where multiple schedulers are fed in, coming up with a reasonable “Now” can be more complicated. Further note, “Delay” can be considered combining a scheduler with something other than another scheduler, namely time, to produce a new scheduler.

Another operator is “Do,” which involves performing some additional action (e.g., side effect) whenever a particular event, namely scheduling, occurs. The additional action can correspond to logging, tracing, journaling, or code instrumentation, among many other things. Further, the additional action can be performed at different times, for example upon scheduling but prior to execution, upon execution, or after execution. An example implementation of performing an additional action upon scheduling is as follows:

public static IScheduler Do(this IScheduler scheduler, Action onRun)
{

var withDo = new Func<Action, Action>(a => { onRun( ); return a;
});
return new AnonymousScheduler(

a => scheduler.Schedule(withDo(a)),
(a, t) => scheduler.Schedule(withDo(a), t),
( ) => scheduler.Now

);

}

Notice the signature of the action could be changed as well, for example in order to pass context (e.g., the action and/or the time span passed to Schedule, allowing an action to inspect state closely). This example illustrates nesting of lambda expressions resulting from creation of combinators.

A “Catch” operator can be employed that is configured to perform some additional action on occurrence of an exception. If an action is scheduled that throws and exception, a scheduler can crash upon executing that action, which may have a disastrous effect on a system, for example since no further work can be run. When units of work are unrelated, it may be desirable to simply handle an exception and move on processing other work.

Exceptions can be handled in a variety of ways. For example, some handler code can be running on the spot, which could itself cause another scheduling action to take place. An alternate unit of work could be allowed to run, which is scheduled on the same scheduler (e.g., again protected by handlers). Retries of a unit of work can also be permitted.

A more stateful approach may also be desirable when scheduled units of work have some relationship or causality associated with them. For instance, actions “A” and “B” can be scheduled to execute in that order (e.g., FIFO scheduling). If “A” throws an exception, it may be undesirable to execute “B” since some invariants guaranteed by “A” may not hold. Combinations of other operators could be used to tag scheduled actions with their origin and possibly sequence numbers. If an action scheduled by a certain origin throws, a catch-operator handler-function could call the “IDisposable” to cancel all of the origin's scheduled work beyond this point.

Ignoring various complicating factors described above, a simple catch operator can be implemented as follows:

public static IScheduler Catch<TException>(this IScheduler scheduler,

Func<TException, Action, Action>

handler)

where TException : Exception

{

var withCatch = new Func<Action, Action>(a => ( ) =>
{

try
{

a( );

}
catch (TException ex)
{

handler(ex, a)( );

}

});
return new AnonymousScheduler(

a => scheduler.Schedule(withCatch(a)),
(a, t) => scheduler.Schedule(withCatch(a), t),
( ) => scheduler.Now

);

}

This operator calls the handler passing in some context including the original action (e.g., allowing a non-protected retry), on the spot. Alternatively, the handler could be scheduled itself. This could be generalized by having the handler function accept an “IScheduler” that is passed in by the “Catch” operator (e.g., recursively pointing to the “catching scheduler” or to the original one).

In this implementation, there is “var withCatch=new Func . . . ,” which takes an action and returns an action. In other words, if an action is provided, a new transformed action will be returned that includes desired exception handling. Later in the code, it says “withCatch(a),” which means if an “a” is provided, namely the action to be scheduled, the action is going to be transformed into a new action that has proper exception handling added. Stated yet another way, given an exception and an action, a new action is returned that does something (e.g., re-run the action) if an exception occurs. An action is packaged that modifies behavior and the new action is scheduled.

Other exception-handling operators are also contemplated including a filtered catch and fault handers, among other things. Associated code either can run immediately or be scheduled in some manner.

To get work done as soon as possible, an ambiguous (Amb) operator can be implemented. Part of such an operator's implementation is shown below, restricted to a binary overload taking in two schedulers for simplicity. Of course, any number of overloads/schedulers can employed. In brief, work can be scheduled on any of the schedulers but running work multiple times is prevented. In other words, if one scheduler gets a chance to run the work, all other schedulers are prevented from running the same work.

public static IScheduler Amb(this IScheduler firstScheduler, IScheduler
secondScheduler)
{

return new AnonymousScheduler(

a =>
{

var gate = default(int);
var m1 = new MutableDisposable( );
var m2 = new MutableDisposable( );
m1.Disposable = firstScheduler.Schedule(( ) =>
{

if (Interlocked.Exchange(ref gate, 1) == 0)
{

m2.Dispose( );
a( );

}

});
m2.Disposable = secondScheduler.Schedule(( ) =>
{

if (Interlocked.Exchange(ref gate, 1) == 0)
{

m1.Dispose( );
a( );

}

});
return new CompositeDisposable(m1, m2);

}

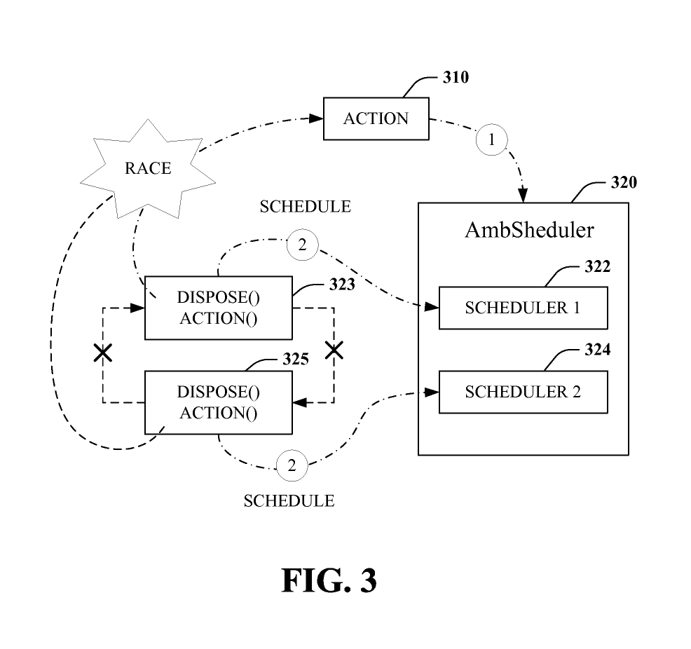

FIG. 3 illustrates operation of an ambiguous (Amb) operation with respect to schedulers. Action 310 representing work to be scheduled for execution is provided to “AmbScheduler” 320 which includes two schedulers scheduler 1 322 and scheduler 2 324. Both schedulers have an opportunity to schedule the action 310 but only one is allowed. Whichever scheduler starts first gets to scheduler the action 310. In other words, there is a race between scheduler 1 322 and scheduler 2 324. The winner, the scheduler that starts first, schedules the action 310. Scheduling is canceled for the loser by calling a dispose action. More particularly, a dispose action 323 can be called to cancel scheduling by scheduler 1 322, or dispose action 325 can be called to cancel scheduling by scheduler 2 324. Amb functionality is analogous to cloning yourself to enable you to stand in two checkout lines at once at a store. The line that enables you to checkout first wins. Further, you only want to check out once to avoid paying twice.

The Amb operator can be extended in quite a few ways to make it more resource-friendly. For example, an n-ary Amb operator would attempt to schedule work on “n” schedulers in a row. However, as soon as work is scheduled, it can be executed at any time in the near or distant future. If that happens, the Amb operator can prevent further scheduling from taking place, as it will be cancelled immediately. Furthermore, performing all such operations can be complicated with regard to synchronization.

Like the “Amb” operator, a “Timeout” operator utilizes multiple schedulers. However, the “Timeout” operator employs multiple schedulers for a different purpose. The role of a “Timeout” operator is to monitor a scheduler's responsiveness by using a watchdog timer. When an action is scheduled on a monitored scheduler, a watchdog timer is started. Once execution of an action begins, a flag is set. If the watchdog timer fires and the flag is not set, an exception can be thrown. Below is an exemplary implementation of a “Timeout” operator.

public static IScheduler Timeout(this IScheduler scheduler, TimeSpan
timeout, IScheduler watchdog)
{

return new AnonymousScheduler(

a =>
{

var hasRun = default(bool);
var s = new MutableDisposable( );
var w = watchdog.Schedule(( ) =>
{

if (!hasRun)
{

s.Dispose( );
throw new TimeoutException(“Scheduler didn't

respond in a timely fashion.”);

}

}, timeout);
s.Disposable = scheduler.Schedule(( ) =>
{

w.Dispose( );
hasRun = true;
a( );

});
return new CompositeDisposable(s, w);

}

Other action could be taken upon noticing unresponsiveness. This could also be generalized using an “IObservable<Action>” on the resulting scheduler that can be subscribed to in order to provide whatever action is desirable upon a timeout for the action that was scheduled.

There are many other potential operators. For example, a multicast operator can be employed to schedule work on multiple schedulers. Consider a situation where a file is to be copied to many different computers. Here, one scheduler can represent a hundred different computers, and the action can be scheduled on one machine and replicated to all other machines. Repeat is another operator that schedules work a given number of times on the same scheduler (including a finite number of times or doing so infinitely). A round robin operator can schedule work on different schedulers from a sequence. This could be based on time or count to switch to the next scheduler in the sequence.

Throttle is an operator that can prevent a scheduler from having a queue of work that is too deep. If an amount of work reaches a threshold (queue reaches a particular length), an exception can be thrown, work can be offloaded to another scheduler, or work could be delayed, among other things. For instance, if a throttle scheduler resides on a mobile phone, the threshold might depend on battery life, such that if a battery charge is low, throttling can be performed more aggressively to throw away actions or defer execution to preserve battery life.

In a similar vein, an auction can be held based on a cost model such that an action can negotiate with a scheduler regarding whether an action runs at a high priority or a low priority depending on load, or energy usage, among other things. Schedulers are typically thought of as something that operates at a low level close to hardware, but they can operate on a higher level such as a virtual machine or cloud where an auction makes sense.

A related operator example can involve work-stealing techniques that bundle up multiple schedulers by giving all of them a separate private queue. Here, each scheduler runs a queue draining work item that consults the local queue but steals work from other schedulers' queues when their own queue is empty.

Logging is an operator that is a special case of a “Do” operator revealing information and performance counters concerning what a scheduler is doing, for instance as an “IObservable<LogInfo>.” A more complex implementation of logging can be trace-based just-in-time compilation. For instance, if a certain sequence of actions is observed to be scheduled multiple times, a transformation can be performed that can replace the sequence of actions with a more efficient version thereof.

A security operator can enforce one or more security policies based on context of a schedule call such as who the entity is that is attempting to schedule work and what credentials the entity has. This can be performed at the point an action is being executed since the original call stack may be gone.

A speculative operator can also be employed that tries to schedule an action, designated for execution in the future, immediately. For instance, if an action is scheduled for execution in an hour, it can be executed immediately. Once this is done, scheduled execution can return the result at the appropriate time. Work is being done upfront, but the results are still delivered at the scheduled time. If this does not work, results can be rolled back.

Similarly, a cache operator can be utilized that caches the result of an action for a certain period based on a policy, for instance. By way of example, a policy dictate that an action is scheduled based on the identity of an action such that it can be recognized that an action was executed within the last couple minutes so instead of running the action again, the result can simply be returned and associated side-effects performed.

A conversion operator can also be employed that transforms actions into a desired form. For instance, if there is a scheduler that operators on an X86 architecture, that scheduler can be converted into a scheduler that operates over an ARM (Advanced Reduced instruction set) architecture.

Further, a deterministic operator can be employed that transforms a non-deterministic scheduler into a deterministic scheduler. For example, a provided scheduler is provided can be assumed to be non-deterministic. Non-determinism can come in two forms, namely from parallelism inherent in a scheduler and from a variable amount of time delay. Parallelism can be eliminated by taking actions one at a time, and the variable time delay can be eliminated by using some canonical manner of execution.

Most, if not all, of the above example operators pertain to algebraic schedulers where things are added to a scheduler. However, co-algebraic schedulers or operators are also possible where a scheduler is split into multiple facets. For example, suppose there is a reader/writer scheduler that performs both reading and writing. That scheduler could be split a reader scheduler and a writer scheduler. As a result, many actions scheduled on the reader scheduler can run in parallel, but when a writer action is scheduled, that action happens exclusively, thereby providing a reader-writer lock with scheduler actions.

Another example of a co-algebraic scheduler can involve dividing an action into smaller actions such that actions can be cancelled or rescheduled in smaller portions. The division of actions can be performed automatically and/or semi-automatically with input from a programmer via annotations, for instance, regarding portions that can be split.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, a combinator, or operator, can employ such mechanisms to generate adaptive or intelligent schedulers.

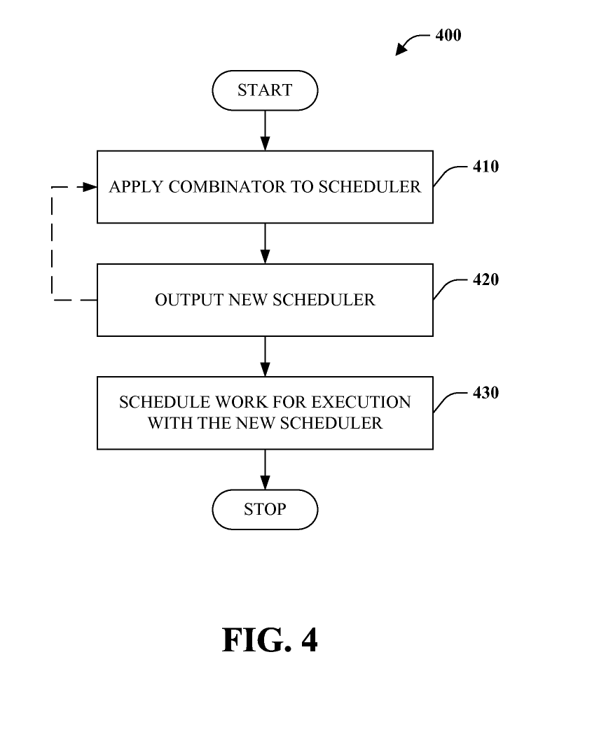

In view of the exemplary systems described supra, methodologies that may be implemented in accordance with the disclosed subject matter will be better appreciated with reference to the flow chart of FIG. 4. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a flow chart diagram of a method of facilitating scheduling is illustrated. At reference numeral 410, a combinator, or operator, is applied to a scheduler. A new scheduler (or multiple schedulers, among other things) can be output as a result of application of the operator. As noted by the dashed arrow, the actions of 410 and 420 can be repeated many times to build up, or compose a desired scheduler. Operators can be applied to schedulers produced as a result of application of other operators to a scheduler. In this manner, schedulers are compositional. At reference numeral 430, work, or an action, can be scheduled for execution with the new scheduler. In other words, work is scheduled as a function of scheduler composition.

As used herein, the terms “component” and “system” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘A’ and ‘B,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

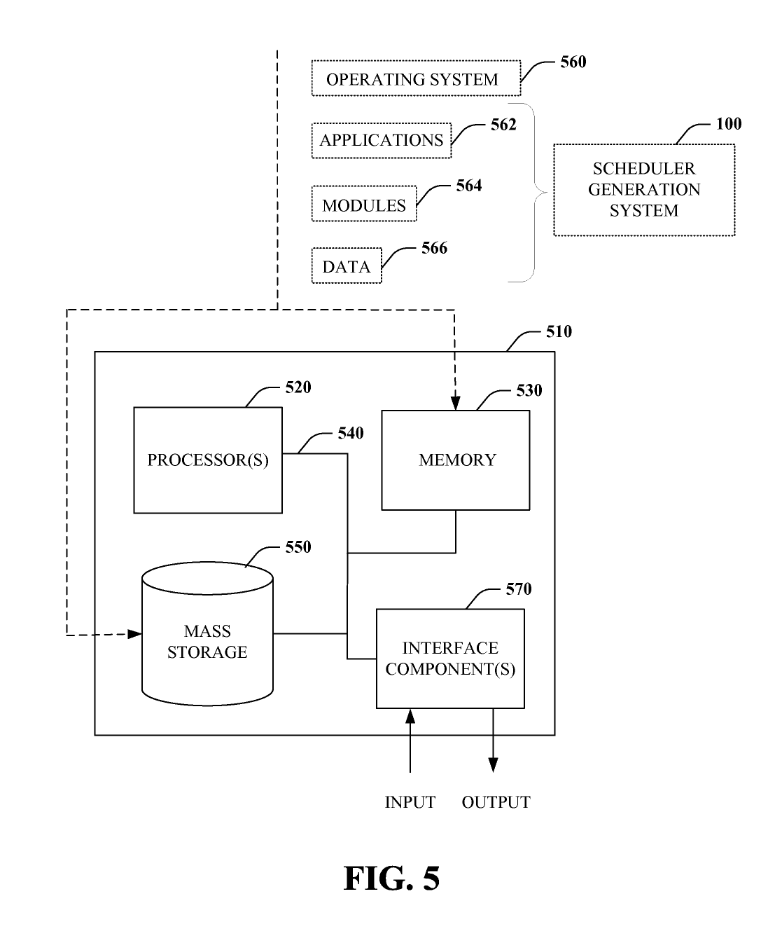

In order to provide a context for the claimed subject matter, FIG. 5 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 5, illustrated is an example general-purpose computer 510 or computing device (e.g., desktop, laptop, server, hand-held, programmable consumer or industrial electronics, set-top box, game system . . . ). The computer 510 includes one or more processor(s) 520, memory 530, system bus 540, mass storage 550, and one or more interface components 570. The system bus 540 communicatively couples at least the above system components. However, it is to be appreciated that in its simplest form the computer 510 can include one or more processors 520 coupled to memory 530 that execute various computer executable actions, instructions, and or components stored in memory 530.

The processor(s) 520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 520 may also be implemented as a combination of computing devices, for example a combination of a DSP and a microprocessor, a plurality of microprocessors, multi-core processors, one or more microprocessors in conjunction with a DSP core, or any other such configuration.

The computer 510 can include or otherwise interact with a variety of computer-readable media to facilitate control of the computer 510 to implement one or more aspects of the claimed subject matter. The computer-readable media can be any available media that can be accessed by the computer 510 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 510.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 530 and mass storage 550 are examples of computer-readable storage media. Depending on the exact configuration and type of computing device, memory 530 may be volatile (e.g., RAM), non-volatile (e.g., ROM, flash memory . . . ) or some combination of the two. By way of example, the basic input/output system (BIOS), including basic routines to transfer information between elements within the computer 510, such as during start-up, can be stored in nonvolatile memory, while volatile memory can act as external cache memory to facilitate processing by the processor(s) 520, among other things.

Mass storage 550 includes removable/non-removable, volatile/non-volatile computer storage media for storage of large amounts of data relative to the memory 530. For example, mass storage 550 includes, but is not limited to, one or more devices such as a magnetic or optical disk drive, floppy disk drive, flash memory, solid-state drive, or memory stick.

Memory 530 and mass storage 550 can include, or have stored therein, operating system 560, one or more applications 562, one or more program modules 564, and data 566. The operating system 560 acts to control and allocate resources of the computer 510. Applications 562 include one or both of system and application software and can exploit management of resources by the operating system 560 through program modules 564 and data 566 stored in memory 530 and/or mass storage 550 to perform one or more actions. Accordingly, applications 562 can turn a general-purpose computer 510 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, scheduler generation system 100, or portions thereof, can be, or form part, of an application 562, and include one or more modules 564 and data 566 stored in memory and/or mass storage 550 whose functionality can be realized when executed by one or more processor(s) 520.

In accordance with one particular embodiment, the processor(s) 520 can correspond to a system on a chip (SOC) or like architecture including, or in other words integrating, both hardware and software on a single integrated circuit substrate. Here, the processor(s) 520 can include one or more processors as well as memory at least similar to processor(s) 520 and memory 530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the scheduler generation system 100 and/or associated functionality can be embedded within hardware in a SOC architecture.

The computer 510 also includes one or more interface components 570 that are communicatively coupled to the system bus 540 and facilitate interaction with the computer 510. By way of example, the interface component 570 can be a port (e.g., serial, parallel, PCMCIA, USB, FireWire . . . ) or an interface card (e.g., sound, video . . . ) or the like. In one example implementation, the interface component 570 can be embodied as a user input/output interface to enable a user to enter commands and information into the computer 510 through one or more input devices (e.g., pointing device such as a mouse, trackball, stylus, touch pad, keyboard, microphone, joystick, game pad, satellite dish, scanner, camera, other computer . . . ). In another example implementation, the interface component 570 can be embodied as an output peripheral interface to supply output to displays (e.g., CRT, LCD, plasma . . . ), speakers, printers, and/or other computers, among other things. Still further yet, the interface component 570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method that facilitates scheduling, comprising:
employing at least one processor configured to execute computer-executable instructions stored in memory to perform the following acts:
scheduling work for execution as a function of scheduler composition.

2. The method of claim 1 further comprises scheduling work for execution based on an operator that creates a new scheduler that delays execution by a given time.

3. The method of claim 1 further comprises scheduling work for execution based on an operator that creates a new scheduler that executes a given action when scheduling takes place.

4. The method of claim 1 further comprises scheduling work for execution based on an operator that creates a new scheduler that performs exception handling.

5. The method of claim 1 further comprises scheduling work for execution based on an operator that creates a new scheduler that takes multiple schedulers and schedules work utilizing one or the multiple schedulers that schedules work first.

6. The method of claim 1 further comprises scheduling work for execution based on an operator that creates a new scheduler that performs an action if a piece of work is not executed within given time period.

7. The method of claim 1 further comprises scheduling work for execution based on an operator that creates a new scheduler that schedules the work on multiple schedulers.

8. The method of claim 1 further comprises scheduling work for execution based on an operator that creates a new scheduler that schedules the work on a series schedulers over time.

9. The method of claim 1 further comprises scheduling work for execution based on an operator that creates a new scheduler that performs an action if a work queue for the scheduler exceeds a given length.

10. The method of claim 1 further comprises scheduling work for execution based on an operator that creates a new scheduler that performs speculative execution.

11. The method of claim 1 further comprises scheduling work for execution based on a co-algebraic operator.

12. A system that facilitates scheduling, comprising:
a processor coupled to a memory, the processor configured to execute the following computer-executable components stored in the memory:
a first component composed from a sequence of one or more operators over a scheduler configured to schedule an action for execution on computational resources.

13. The system of claim 12, one of the one or more operators is configured to delay execution of the action by a given time.

14. The system of claim 12, one of the one or more operators is configured to perform additional action before, after, or during execution of the action.

15. The system of claim 12, one or the one or more operators is configured to perform an additional action if a threshold number of actions are queued by the scheduler.

16. The system of claim 12, one or the one or more operators is configured to reschedule work on the scheduler a given number of times.

17. The system of claim 12, one or the one or more operators is configured to enforce a security policy based on context surrounding the action scheduled.

18. The system of claim 12, one of the one or more operators is configured to split the scheduler into multiple facets.

19. A method facilitating scheduling, comprising:
employing at least one processor configured to execute computer-executable instructions stored in memory to perform the following acts:
composing a scheduler configured to schedule an action for execution on hardware by application of a chain of one or more scheduler combinators.

20. The method of claim 19 further comprises composing the scheduler to control at least one of when a subscription starts or when to publish a notification.
